(19) United States
(12) Patent Application Publication
(10) Pub. No.: US 2009/0002892 A1
(43) Pub. Date: Jan. 1, 2009

(54) HEAD SUPPORT MECHANISM AND DISK DEVICE PROVIDED WITH THE SAME

(75) Inventor: Masaya Kudo, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/144,848

(22) Filed: Jun. 24, 2008

(30) Foreign Application Priority Data
Jun. 29, 2007 (JP) 2007-173277

(51) Int. Cl. G11B 5/48

(52) U.S. Cl. 360/244.2

(57) ABSTRACT

According to one embodiment, a head support mechanism includes a plate-shaped arm, a load beam in the form of an elongated plate having a distal end portion on which a head is supported and a proximal end portion spaced from the distal end portion; and a hinge plate which connects the arm and the proximal end portion of the load beam and has a load bending portion which is subjected to bending work and applies a predetermined load to the head. The load beam includes a sub-bent portion which is less stiff than any other parts of the load beam, and the hinge plate includes a traverse portion which is fixed overlapping the sub-bent portion on the load beam and configured to adjust the stiffness of the sub-bent portion.

### CROSS-REFERENCE TO RELATED APPLICATIONS

This application is based upon and claims the benefit of priority from Japanese Patent Application No. 2007-173277, filed Jun. 29, 2007, the entire contents of which are incorporated herein by reference.

### BACKGROUND

1. Field

One embodiment of the present invention relates to a head support mechanism, such as a head gimbal assembly that supports a head, and a disk device provided with the same.

2. Description of the Related Art

A disk device, e.g., a magnetic disk device, generally includes a magnetic disk, spindle motor, magnetic head, carriage assembly, voice coil motor, flexible printed circuit board (FPC) unit, etc. The magnetic disk is disposed in a case. The spindle motor supports and rotates the disk. The magnetic head writes and reads information to and from the disk. The carriage assembly supports the head for movement with respect to the disk. The voice coil motor serves to drive the carriage.

The carriage assembly includes a bearing portion mounted on a case, a plurality of head gimbal assemblies (HGAs) stacked on the bearing portion, a voice coil that constitutes a voice coil motor, etc. Each HGA that functions as a head support mechanism is provided with an arm rotatably supported on the bearing portion, a plate-shaped load beam extending from the arm, and a hinge plate that connects the arm and the load beam. A magnetic head is supported on an extended end of the load beam. The arm, hinge plate, and load beam are joined together by welding or the like.

The hinge plate is formed of a metal plate and includes a load bending portion that is previously subjected to bending work. The load bending portion is configured to generate an appropriate pressure load in the magnetic head when the head is loaded on the disk. For higher stiffness, some load beams are formed with side rail portions on their opposite side edges, right and left. As disclosed in Jpn. Pat. Appln. KOKAI Publication No. 8-329636, there is proposed an HGA that is provided with bent portions at the side rail portions, whereby the head load can be adjusted.

When the magnetic head is loaded on the disk, the load beam and the hinge plate are deformed in the respective positions of the load bending portion and the bent portions by a bending moment to compensate for a load that is generated in the head. The resulting loaded posture is called a deformed posture.

The resonance characteristic of the head support mechanism is closely related to the loaded deformed posture. In order to design the head support mechanism with an optimum resonance characteristic, it is essential to design the deformed posture optionally. On the other hand, the deformed posture of the head support mechanism is settled substantially depending on the amount of load, the relative heights of the HGA and the disk, the thicknesses and lengths of the load beam and the hinge plate, etc. It is different, therefore, to secure a high degree of freedom for the design of the head support mechanism.

The deformed posture may be changed by subjecting the load beam, as well as the load bending portion, to minor bending work at several spots. In this case, however, there are problems that the load beam requires more machining processes and that the resonance characteristic varies due to the variation of the bending angle.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing an HDD according to a first embodiment of the invention with its top cover off;

FIG. 2 is an exemplary perspective view of a carriage assembly attached to the HDD;

FIG. 3 is an exemplary perspective view showing the upper surface side of an HGA of the carriage assembly;

FIG. 4 is an exemplary plan view showing that side of the HGA on which a magnetic head is disposed;

FIGS. 5A and 5B are exemplary side views individually showing a no-load state of the HGA and a state in which the HGA is subjected to a head load from the magnetic head;

FIG. 6 is an exemplary plan view showing that side of an HGA according to a second embodiment of the invention on which a magnetic head is disposed; and

FIG. 7 is an exemplary plan view showing that side of an HGA according to a third embodiment of the invention on which a magnetic head is disposed.

### DETAILED DESCRIPTION

Various embodiments according to the invention will be described hereinafter with reference to the accompanying drawings. In general, according to one embodiment of the invention, a head support mechanism comprises: a plate-shaped arm; a load beam in the form of an elongated plate having a distal end portion on which a head is supported and a proximal end portion spaced from the distal end portion; and a hinge plate which connects the arm and the proximal end portion of the load beam and includes a load bending portion which is subjected to bending work and applies a predetermined load to the head, the load beam including a sub-bent portion which is less stiff than any other parts of the load beam, the hinge plate including a traverse portion which is fixed overlapping the sub-bent portion on the load beam and configured to adjust the stiffness of the sub-bent portion.

An embodiment in which this invention is applied to a hard disk drive (HDD) as a disk device will now be described in detail with reference to the accompanying drawings.

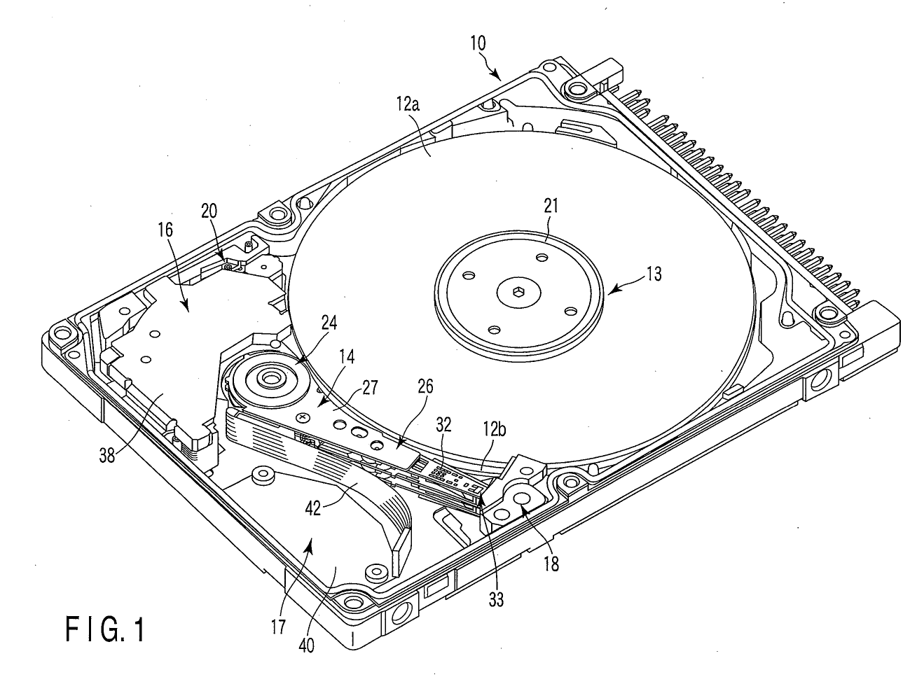

As shown in FIG. 1, the HDD includes a case 10 in the form of an open-topped rectangular box and a top cover (not shown). The top cover is fastened to the case by screws so as to close the top opening of the case.

The case 10 contains two magnetic disks 12a and 12b, a spindle motor 13, magnetic heads, a carriage assembly 14, and a voice coil motor (VCM) 16. The spindle motor 13 supports and rotates the magnetic disks for use as recording media. The heads serve to record and reproduce information to and from the disks. The carriage assembly 14 supports the heads for movement with respect to the disks 12a and 12b. The VCM 16 serves to rotate and position the carriage assembly. The case 10 further contains a ramp load mechanism 18, an inertia latch mechanism 20, and a flexible printed circuit board unit (FPC unit) 17. The ramp load mechanism 18 holds the magnetic heads at distances from the magnetic disks when the heads are moved to the outermost peripheries of the disks. The inertia latch mechanism 20 serves to hold the carriage assembly in a retracted position when the HDD is impacted or jolted. Electronic components, such as a preamplifier, are mounted on the FPC unit 17. The carriage assembly 14 and the FPC unit 17 constitute a head actuator assembly that drives the magnetic heads.

A printed circuit board (not shown) is screwed to the outer surface of the case 10 so as to face a bottom wall of the case. The circuit board controls the operations of the spindle motor 13, VCM 16, and magnetic heads through the FPC unit 17.

The magnetic disks 12a and 12b are formed each having a diameter of, for example, 65 mm (2.5 inches). Each disk has magnetic recording layers on its upper and lower surfaces, individually. The two magnetic disks 12a and 12b are coaxially fitted on a hub (not shown) of the spindle motor 13 and clamped by a clamp spring 21 so that they are stacked in layers at a predetermined space therebetween along the axis of the hub. The magnetic disks 12a and 12b are rotated at a predetermined speed by the spindle motor 13 for use as a drive section.

The carriage assembly 14 is provided with a bearing portion 24 fixed on the bottom wall of the case 10 and four head gimbal assemblies (HGAs) 26 extending from the bearing portion. Each HGA 26 includes an arm 27, a load beam 32, a hinge plate 60 which connects the arm and the load beam, and a magnetic head 33 supported on an extended end of the load beam. The four arms 27 are situated parallel to the surfaces of the magnetic disks and spaced from one another. They extend in the same direction from the bearing portion 24.

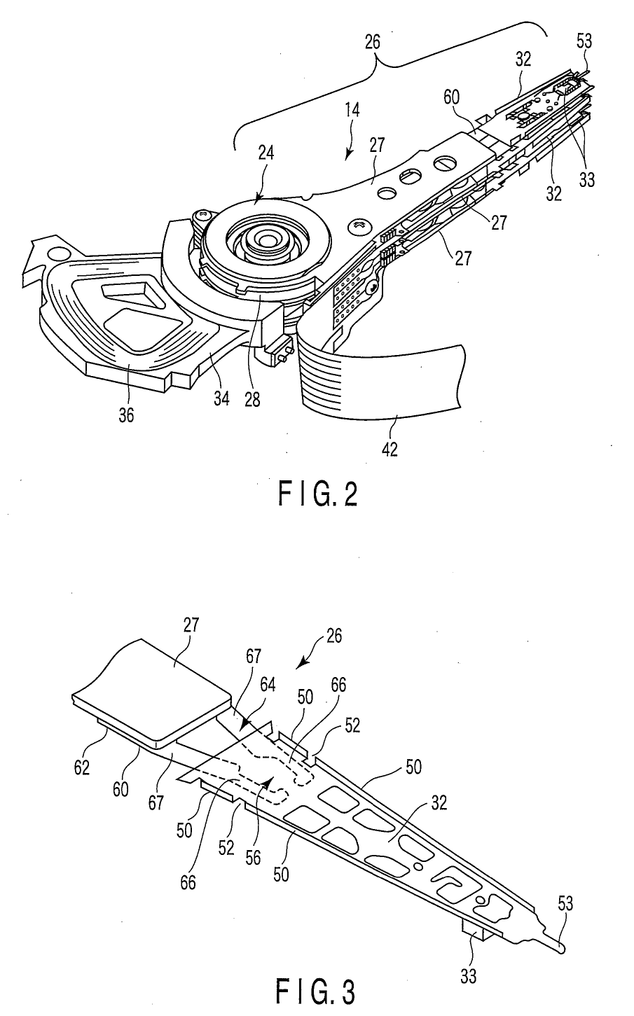

As shown in FIGS. 1 and 2, the carriage assembly 14 includes a support frame 34 that extends from the bearing portion 24 oppositely from the arms 27. The support frame supports a voice coil 36 that constitutes a part of the VCM 16. The support frame 34 is molded from plastic and formed integrally on the outer periphery of the voice coil 36. When the carriage assembly 14 is attached to the case 10, the voice coil 36 is situated between a pair of yokes 38 that are fixed on the case 10 and, in conjunction with these yokes and a magnet (not shown) fixed to one of the yokes, constitutes the VCM 16. If the voice coil 36 is energized, the carriage assembly 14 rotates around the bearing portion 24, whereupon the magnetic heads 33 are moved to and positioned in regions over or under desired tracks of the magnetic disks 12a and 12b.

The ramp load mechanism 18 includes a ramp 51 and tabs 53. The ramp 51 is provided on the bottom wall of the case 10 and located outside the magnetic disks 12a and 12b. The tabs 53 extend individually from the respective distal ends of the load beams 32. As the carriage assembly 14 rotates to its retracted position outside the magnetic disks 12a and 12b, each tab 53 engages a ramp surface on the ramp 51 and is then pulled up along the slope of the ramp surface, whereupon each magnetic head is unloaded.

As shown in FIG. 1, the FPC unit 17 has a body 40 that is formed of a flexible printed circuit board and fixed to the bottom wall of the case 10. The preamplifier and other electronic components are mounted on the body 40. The FPC unit 17 includes a main flexible printed circuit board (main FPC) 42 that extends from the body 40. An extended end of the main FPC 42 is connected to the vicinity of the bearing portion 24 of the carriage assembly 14 and further connected electrically to the magnetic heads 33 by cables (not shown) on the arms 27 and the load beams 32. A connector (not shown) for connection with the printed circuit board is mounted on the bottom surface of the body of the FPC unit 17.

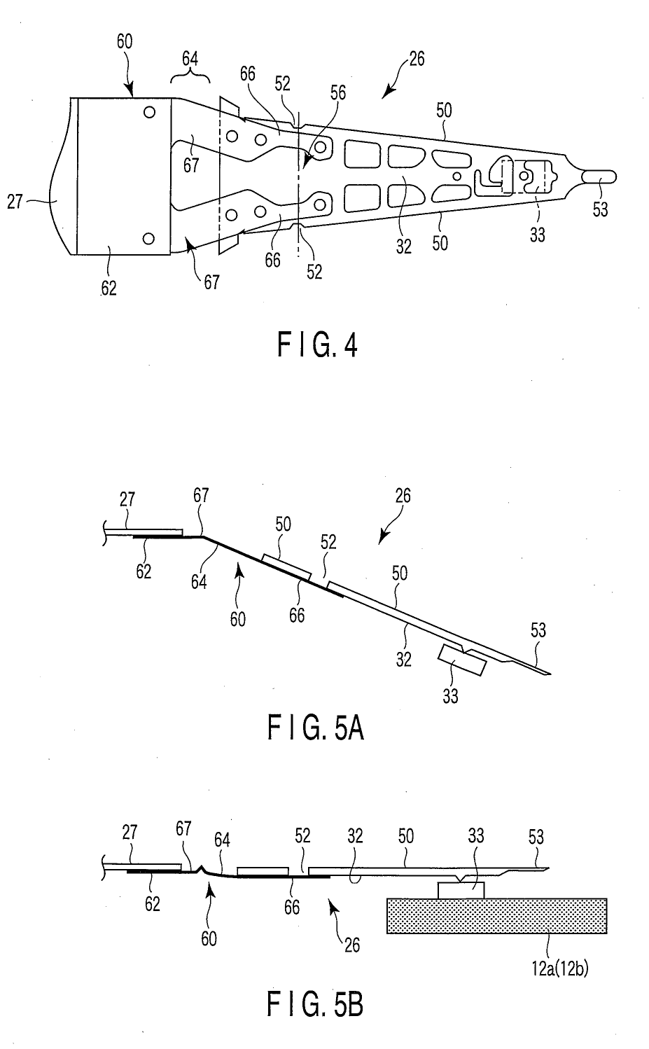

The following is a detailed description of the HGAs 26. As shown in FIGS. 2, 3, 4 and 5, each HGA 26 that functions as a head support mechanism is provided with the arm 27, load beam 32, hinge plate 60 that connects the arm and the load beam, and magnetic head 33 supported on the extended end of the load beam. Each arm 27 is a thin flat plate of a stainless-steel material, such as SUS304, with a thickness of about 300 μm. A through hole (not shown) is formed in the proximal end portion of the arm 27, and the arm 27 is supported on the bearing portion 24 in such a manner that the bearing portion is passed through the through hole.

The load beam 32 is formed of an elongated belt-shaped leaf spring with a thickness of several tens of μm. It has a distal end portion and a proximal end portion spaced from each other. The width of the load beam 32 is gradually lowered from the proximal end portion toward the distal end portion. The tab 53 protrudes from the distal end of the load beam.

The load beam 32 includes a pair of side edges extending along its length and a pair of rail portions 50 formed individually along the side edges. The rail portions 50 are formed by bending the opposite side edge portions substantially at right angles. If the rail portions 50 are formed in this manner, the stiffness of the load beam 32 along its extension can be made about 40% higher than that of a load beam without any rail portions.

On the proximal end side of the load beam 32, substantially rectangular notches 52, for example, are formed individually in the paired rail portions 50 so as to be opposed to each other across the width of the load beam. That region of the load beam 32 which is situated between the pair of notches 52 constitutes a sub-bent portion 56. The sub-bent portion 56 extends between the notches 52 across the width of the load beam 32. The sub-bent portion 56 is less stiff and more bendable than any other parts of the load beam 32.

Further, the load beam 32 need not always be formed by bending a thin plate. Alternatively, it may be formed having the pair of rail portions and the notches by partially thinning a thick plate by etching.

The load beam 32 is located so that its proximal end faces the arm 27 across a gap. The distal end portion of the arm 27 and the proximal end portion the load beam 32 are coupled to each other by the hinge plate 60. The hinge plate 60 is formed of a metal plate with a thickness of, for example, several tens of μm. The hinge plate 60 integrally includes a base portion 62 fixed to the distal end portion of the arm 27, an extending portion 64 extending from the fixed base portion, and traverse portions 66 formed of extended end parts of the extending portion 64 and fixed to the proximal end portion of the load beam 32.

The base portion 62 is a rectangular structure that is superposed on the backside of the arm 27 and fixed to the arm by welding or the like. In the present embodiment, the extending portion 64 is bifurcated. The extending portion 64 is previously bent toward the magnetic disk 12a or 12b and forms load bending portions 67 which apply a predetermined load to the load beam 32.

The two traverse portions 66 that are formed of the extended end parts of the bifurcated extending portion 64 are individually fixedly superposed on the sub-bent portion 56 of the load beam 32. The traverse portions 66 are located across the sub-bent portion 56 and welded to the load beam 32 on the opposite sides of the sub-bent portion. Thus, the two traverse portions 66 serve to adjust the stiffness of the sub-bent portion 56 of the load beam 32 to a predetermined value. More specifically, the stiffness of the sub-bent portion 56 can be changed by altering the width, area, and thickness of each traverse portion 66 that is fixed to the sub-bent portion.

On the other hand, each magnetic head 33 includes a substantially rectangular slider (not shown) and a write/read magnetoresistive (MR) head formed on the slider. The head 33 is fixed to a gimbal portion that is formed on the distal end portion of the load beam 32.

FIG. 5A shows the HGA 26 in a no-load state such that the magnetic head 33 is not loaded on any magnetic disk. FIG. 5B shows the respective postures of the load beam 32 and the hinge plate 60 with the magnetic head 33 on the magnetic disk 12a or 12b. The load beam 32 and the hinge plate 60 are deformed by a bending moment to compensate for a load that is generated in the head 33.

According to the HGA 26 described above, the sub-bent portion 56 is formed on the load beam 32 in addition to the load bending portions 67 on the extending portion 64 of the hinge plate 60, and the sub-bent portion 56 is bent when loaded. The stiffness of the sub-bent portion 56 can be adjusted to optionally increase or reduce the flexure of the loaded sub-bent portion by changing the width, area, and thickness of each traverse portion 66 of the hinge plate 60 that is fixedly superposed on the sub-bent portion. In consequence, the deformed posture of the load beam 32 can be adjusted to design the resonance characteristic of the HGA 26 in an optimum manner.

According to the HDD constructed in this manner, the deformed posture of the load beam can be changed to increase the degree of freedom of the resonance design without subjecting the load beam 32 to bending work. Specifically, the deformed posture of the load beam can be adjusted by means of the sub-bent portion on the load beam and the hinge plate superposed thereon, instead of performing bending work on the load beam. Thus, there may be provided a head support mechanism, of which the resonance design can be increased in the degree of freedom by changing the deformed posture of the load beam without performing bending work, and a disk device provided with the same.

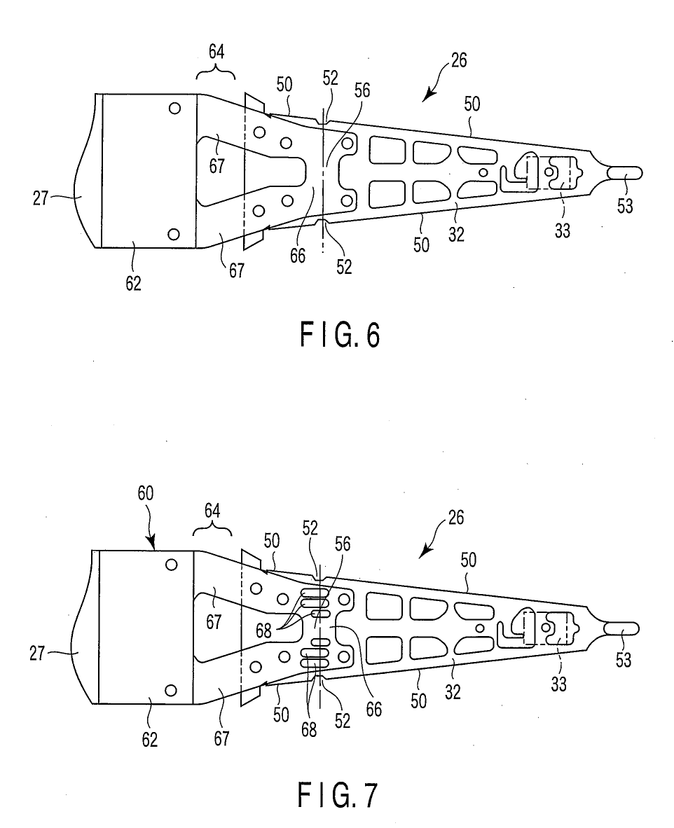

The following is a description of an HGA according to another embodiment of the invention. As mentioned before, the stiffness of the sub-bent portion 56 of the load beam 32 can be adjusted by changing the width, area, and shape of each traverse portion 66 of the hinge plate 60. According to a second embodiment, as shown in FIG. 6, an extending portion 64 of a hinge plate 60 is bifurcated, and a traverse portion 66 extends connecting two opposite extended ends of the extending portion. The traverse portion 66 is located overlapping a sub-bent portion 56 on a load beam 32 and welded to the load beam at a plurality of spots on the opposite sides of the sub-bent portion.

According to a third embodiment, as shown in FIG. 7, an extending portion 64 of a hinge plate 60 is bifurcated, and a traverse portion 66 extends connecting two opposite extended ends of the extending portion. The traverse portion 66 is located overlapping a sub-bent portion 56 on a load beam 32 and welded to the load beam at a plurality of spots on the opposite sides of the sub-bent portion. Further, the traverse portion 66 is formed with a plurality of adjustment holes 68 for adjusting the stiffness of the traverse portion 66 and the sub-bent portion 56. The adjustment holes 68 serve to change the area and stiffness of the traverse portion 66.

In the second and third embodiments, other configurations of each HGA and the HDD are the same as those of the first embodiment, so that like reference numbers are used to designate like portions, and a detailed description thereof is omitted. The same functions and effects of the first embodiment can also be obtained with the second and third embodiments.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

The disk device of this invention is not limited to one that uses 2.5-inch disks, but the invention is also applicable to disk devices that use 1.0- or 1.8-inch disks, for example. The numbers of magnetic disks and magnetic heads are not limited to the foregoing embodiments but may be increased or decreased as required.

What is claimed is:

1. A head support mechanism comprising:
a plate-shaped arm;
a load beam in the form of an elongated plate having a distal end portion on which a head is supported and a proximal end portion spaced from the distal end portion; and
a hinge plate which connects the arm and the proximal end portion of the load beam and includes a load bending portion which is subjected to bending work and applies a predetermined load to the head,
the load beam including a sub-bent portion which is less stiff than any other parts of the load beam,
the hinge plate including a traverse portion which is fixed overlapping the sub-bent portion on the load beam and configured to adjust the stiffness of the sub-bent portion.

2. The head support mechanism according to claim 1, wherein the load beam includes a pair of side edges extending along the length thereof, a pair of rail portions formed individually along the side edges, and a pair of notches formed in a part of the rail portions, a region situated between the pair of notches constituting the sub-bent portion.

3. The head support mechanism according to claim 2, wherein the pair of rail portions are formed by bending two opposite side edge portions of the load beam.

4. The head support mechanism according to claim 1, wherein the hinge plate includes a base portion fixed to the arm, a fixed portion which is fixed to the load beam and constitutes the traverse portion, and an extending portion extending between the base portion and the fixed portion and including the load bending portion.

5. The head support mechanism according to claim 4, wherein the extending portion and the fixed portion are bifurcated and form two traverse portions.

6. The head support mechanism according to claim 4, wherein the extending portion is bifurcated, and the traverse portion connects two opposite extended ends of the extending portion.

7. The head support mechanism according to claim 1, wherein the hinge plate is provided with an adjustment hole which is formed in the traverse portion and serves to adjust the stiffness of the sub-bent portion.

8. The head support mechanism according to claim 1, wherein the traverse portion is located across the sub-bent portion of the load beam and welded to the load beam on two opposite sides of the sub-bent portion.

9. A disk device comprising:
a disk-shaped recording medium;
a drive section which supports and rotates the recording medium;
a head which performs information processing for the recording medium; and
a head support mechanism which supports the head, the head support mechanism comprising: a plate-shaped arm; a load beam in the form of an elongated plate having a distal end portion on which a head is supported and a proximal end portion spaced from the distal end portion; and a hinge plate which connects the arm and the proximal end portion of the load beam and includes a load bending portion which is subjected to bending work and applies a predetermined load to the head,
the load beam including a sub-bent portion which is less stiff than any other parts of the load beam,
the hinge plate including a traverse portion which is fixed overlapping the sub-bent portion on the load beam and configured to adjust the stiffness of the sub-bent portion.
